(19) United States
(12) Patent Application Publication
(10) Pub. No.: US 2026/0293847 A1
(43) Pub. Date: Oct. 1, 2026

(54) MODULAR SYSTEM FOR AN ANIMAL DRINKER

(71) Applicant: Hawkeye Steel Products, Inc, Houghton, IA (US)

(72) Inventor: Jonathan Reed WENSTRAND, Mt. Pleasant, IA (US)

(21) Appl. No.: 19/636,605

(22) Filed: Apr. 1, 2026

Related U.S. Application Data
(60) Provisional application No. 63/781,724, filed on Apr. 1, 2025.

(51) Int. Cl. A01K 7/02

(52) U.S. Cl. CPC A01K 7/025

(57) ABSTRACT

A modular system for making an animal waterer is described herein. Side walls and corner sections are assembled to make an animal waterer of a desired length and width and height. A water supply member provides water and can be activated automatically or manually.

### CROSS-REFERENCE TO RELATED APPLICATIONS

The present application claims priority to provisional patent application 63/781,724 which was filed on Apr. 1, 2025, and is hereby expressly incorporated by reference in its entirety.

### BACKGROUND

In recent years, dairy farms and other livestock operations have become much larger. Larger operations require additional infrastructure such as animal waterers. Depending on the preferences of the owner or operator, there is a need for waterers with different lengths, heights, and widths. In dairy operations in particular, water consumption is closely monitored, as water intake is a key factor in milk production.

The current state of the art utilizes concrete, galvanized/stainless steel or polyethylene as the material for animal waterers. The molds associated with the steel or polyethylene waterers can cost up to $100,000 each, and concrete molds are also expensive. Due to those costs, it is impractical to offer a variety of lengths, heights, and widths to dairy farms and other livestock operations.

In addition to cost considerations, transporting rotational molded poly, galvanized or stainless steel, and concrete waterers presents logistical challenges. Concrete waterers are significantly limited by weight, causing truckloads to reach maximum allowable weight with a relatively low number of units. In contrast, rotational molded poly and steel waterers are generally limited by their size and shape, resulting in inefficient use of available shipping volume. The modular drinker design, being relatively lightweight and capable of being shipped in a broken-down, nestable configuration, allows substantially more units to be transported per truckload.

It is an object of the invention to provide a modular system that can be easily modifiable to achieve a variety of heights, lengths and widths.

It is further an object of the invention that the water inlet(s) can be positioned at various locations; further that multiple water inlets can be located along the trough (this is especially important when the troughs become very long---say 12 to 14 feet long).

It is further an object of the invention that the waterer can use heaters or continuous flow

It is further an object of the invention that the access doors can also be positioned in various locations. This is important for placement and removal of heaters and also for any required trouble shooting.

It is a further object of the invention to provide a modular system that can be shipped and then assembled on a farm.

### SUMMARY OF THE INVENTION

A modular system for an animal waterer. The modular system includes side wall panels, each having a first side and a second side. The first side of a first panel can be connected to the second side of a second panel. Accordingly, incremental adjustments in length, width and height can be achieved for a particular animal waterer.

The modular system design allows units to be shipped broken down and nestable, significantly increasing the number of drinkers that can be transported per truckload when compared to concrete, steel or rotational molded poly waterers.

The modular system described herein can be made from materials including plastic and extruded aluminum. Plastics utilized can include standard polyvinyl chloride, structural foam polyvinyl chloride, and other similar gluable plastics.

### BRIEF DESCRIPTION OF THE DRAWINGS

FIG. 1 is a perspective view of a wall panel of the modular system;

FIG. 2 is a perspective view of the modular system for an animal waterer with a plurality of wall panels connected to one another;

FIG. 3 is a perspective view of the modular system for an animal waterer detailing the connection of two wall panels;

FIG. 4 is an exploded view of the modular system for an animal waterer;

FIG. 5 is a perspective view of the anchoring parts of the modular system;

FIG. 6 is a perspective view showing an optional door and a water cover.

### DETAILED DESCRIPTION

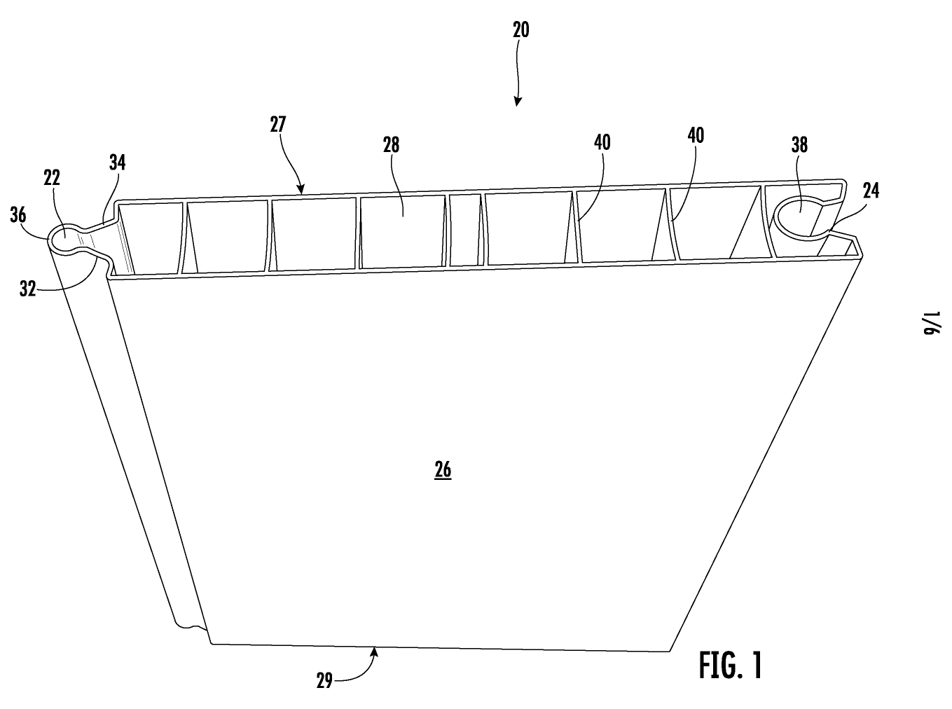

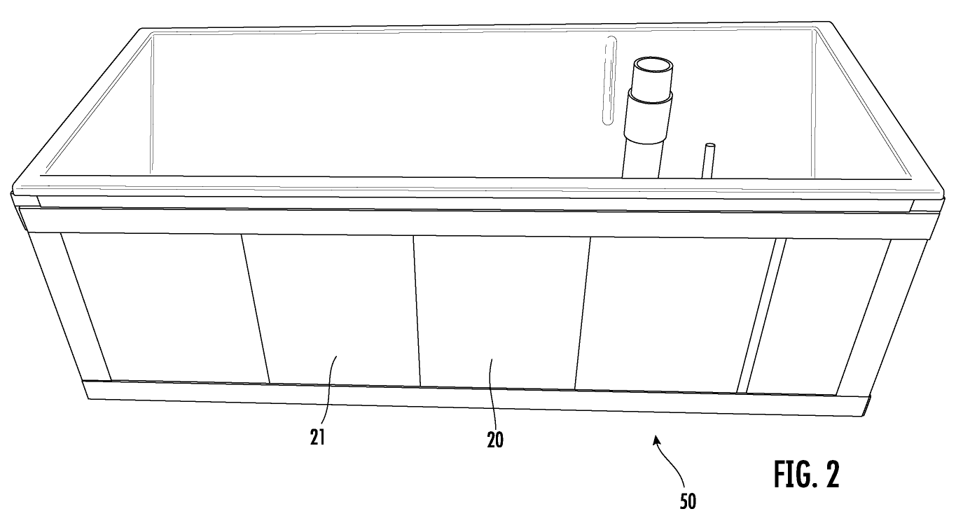

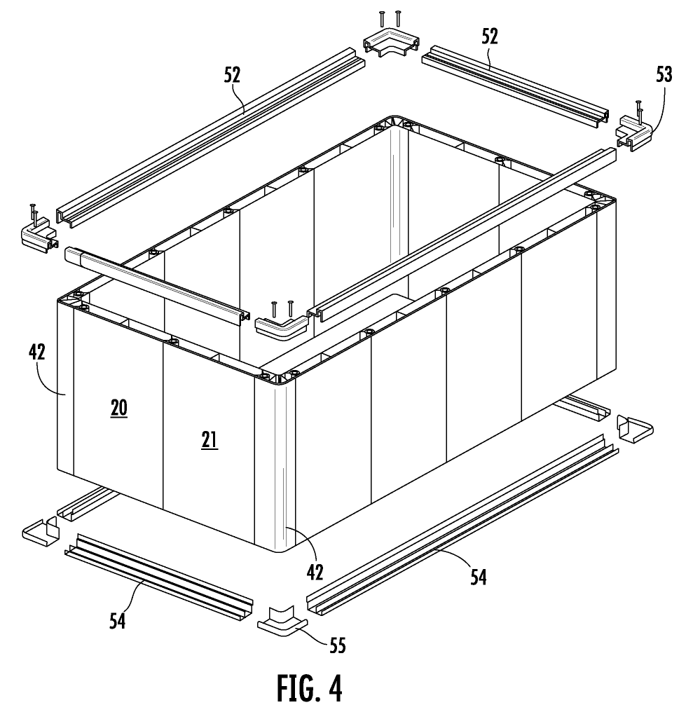

Now referring to FIGS. 1-6, a modular system for an animal waterer is detailed. FIG. 1 shows a wall panel 20 of a modular system for an animal waterer 50 best seen in FIGS. 2 and 4. The wall panel 20 has a first side 22 and a second side 24. The panel 20 has a front side 26, a back side 27, a bottom 29 and a top 28. The wall panel 20 has a plurality of support members 40 that span from the front side 26 to the back side 27 to support the animal waterer 50, particularly when filled with a liquid.

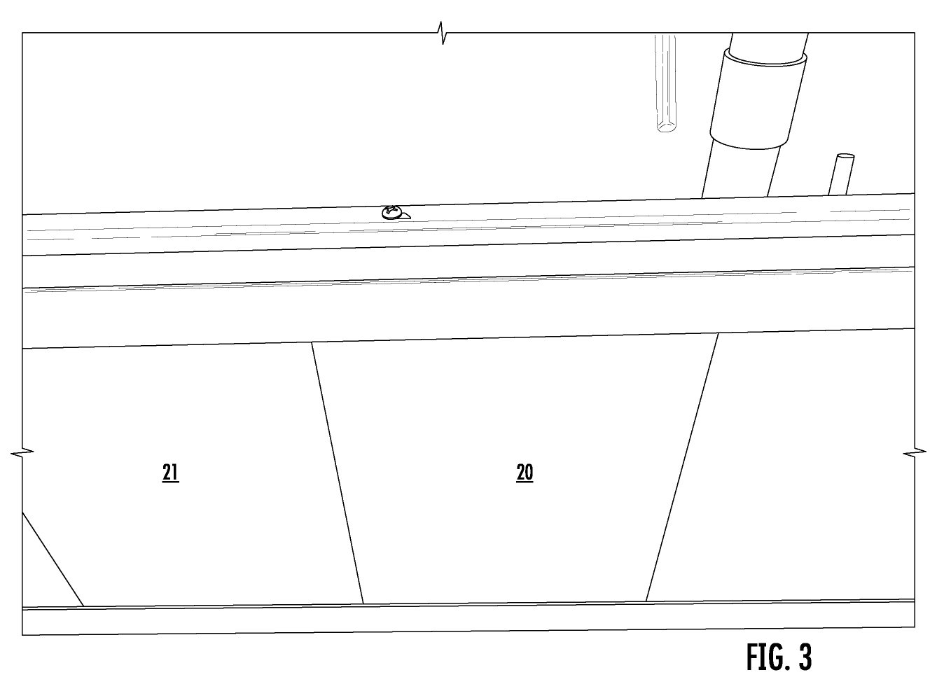

The first side 22 is shaped such that it can be fit into the second side 24. Accordingly, a first panel 20 can be selectively attached to a second panel 21 by sliding the first side 22 of the first panel 20 into the second side 24 of the second panel 21 from an upward or downward direction. Any number of panels 20 can be utilized to achieve the desired length of the animal waterer 50. Similarly, the width of the animal waterer 50 can also be varied by the same method. This can best be seen in FIGS. 2 and 3. The height of the animal waterer 50 can be selected by the overall height of the panel 20.

In the preferred embodiment, the first side 22 of the first wall panel 20 has a first extension member 32 and a second extension member 34 that extend from the front side 26 and the back side 27 respectively. A rounded edge 36 protrudes from the first and second extension members. The second side 24 has a shape that corresponds to the shape of the first side 36. As described above, the first side 22 is slidable into the second side 24.

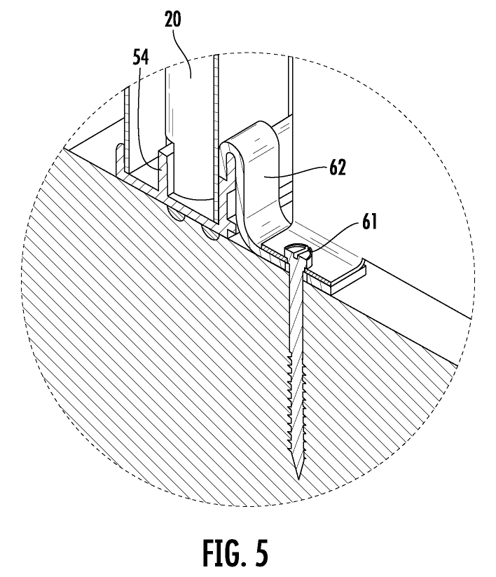

FIG. 4 shows several panels 20 linked together along with a top rail 52 and a bottom rail 54. The panels 20 of a sidewall will tie into the top rail 52 and the bottom rail 54 at the top 28 and bottom 29 respectively. Furthermore, as shown in FIG. 5, the animal waterer 50 will be anchored down in to the ground or in concrete via an anchor plate 60 that attaches to the base rail 54. The anchor plate 60 is anchored into a base 70 preferably made of concrete via an anchor screw 61. A further feature of the design is that the anchor locations are not fixed and can be customized.

FIG. 4 also demonstrates that there are corner panels 42 that can be utilized to connect two wall panels 20. The corner panels are shaped similarly to the wall panel 20 and can be attached to one or more wall panels 20. The top rail 52 comprises corner rails 53, while the bottom rail 54 comprises corner rails 55.

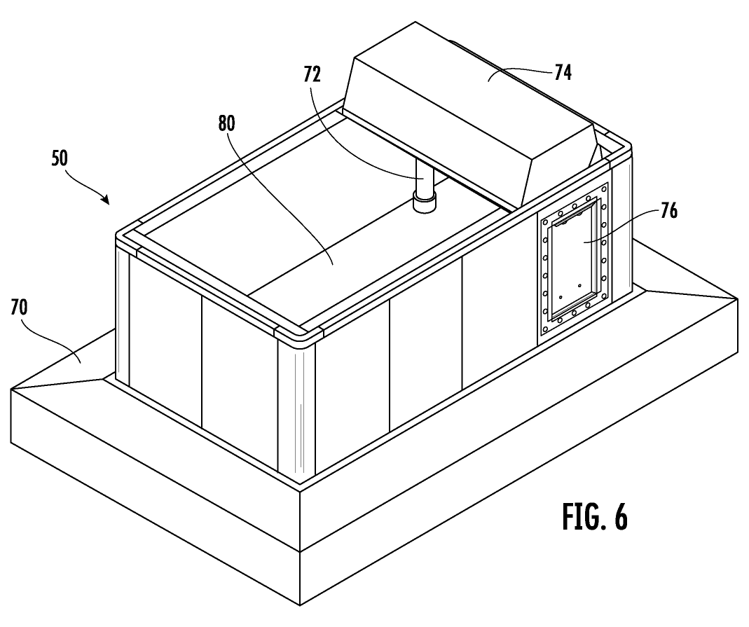

FIG. 6 demonstrates an animal waterer 50 wherein it rests on the base 70. The base 70 forms the bottom 80 of the animal waterer 50. A water supply member 72 supplys water to the animal waterer 50. A water cover 74 can cover the water supply member 72. An access door 76 can be added to one or more of the wall panels 20 to allow access to certain parts of the animal waterer 50. Although not shown, a heater can be used to maintain a particular temperature of the water contained in the animal waterer 50.

Having thus described the invention in connection with the several embodiments thereof, it will be evident to those skilled in the art that various revisions can be made to the several embodiments described herein with out departing from the spirit and scope of the invention. It is my intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A modular system for an animal waterer, comprising:
a wall panel;
the wall panel having a first side and a second side;
the first side of a first wall panel selectively attachable to the second side of a second wall panel;
wherein a plurality of attached wall panels is configured to be a side wall of the modular animal waterer.

2. The modular system of claim 1, wherein:
the first side of the first wall panel comprises a first extension member;
the first side of the first wall panel comprises a second extension member.

3. The modular system of claim 2, wherein:
the first side of the first wall further comprises a rounded edge.

4. The modular system of claim 3, wherein:
the second side of the second wall has a shape that corresponds to a shape that accommodates a shape of the first side of the first wall.

5. The modular system of claim 4, further comprising:
at least one corner section that can connect the first wall to another second wall.

6. The modular system of claim 5, wherein:
the walls are connected to a base.

7. The modular system of claim 6, further comprising:
a bottom rail;
the bottom rail comprises sections that are weathersealed to prevent leakage.

8. The modular system of claim 7, wherein:
a water supply member fills the modular system with water.

9. The modular system of claim 8, wherein:
the base forms a bottom of the animal waterer.

10. The modular system of claim 9, wherein:
the bottom rail has at least one corner rail.

11. The modular system of claim 10, wherein:
the modular system is anchored to the base.

12. An animal waterer, comprising:
a series of interconnectable walls,
the walls connected to a base,
a top rail connected to the walls.

13. The animal waterer of claim 12, comprising:
a wall panel;
the wall panel having a first side and a second side;
the first side of a first wall panel selectively attachable to the second side of a second wall panel;
wherein a plurality of attached wall panels is configured to be a side wall of the modular animal waterer.

14. The animal waterer of claim 13, wherein:
a base forms the bottom of the animal waterer.

15. The animal waterer of claim 14, wherein:
a bottom rail forms a water tight seal between the walls and the base.
